(19) United States
(12) Patent Application Publication
(10) Pub. No.: US 2013/0122165 A1
(43) Pub. Date: May 16, 2013

(54) COMPOSITION AND METHOD FOR TREATING FRESH PRODUCE

(71) Applicants: John Powell Ricks, Idaho Falls, ID (US); John Powell Ricks, Idaho Falls, ID (US)

(72) Inventors: John Powell Ricks, Idaho Falls, ID (US); John Powell Ricks, Idaho Falls, ID (US)

(21) Appl. No.: 13/465,926

(22) Filed: May 7, 2012

Related U.S. Application Data
(60) Provisional application No. 61/483,315, filed on May 6, 2011.

(51) Int. Cl. A23L 3/3463

(52) U.S. Cl. CPC A23L 3/34635
USPC 426/335; 426/532

(57) ABSTRACT

A chemical composition and method for cleaning and increasing crispness of fresh produce includes an aqueous solution containing sodium chloride, citric acid, ascorbic acid and D-alpha-tocopheryl acetate. Fresh, produce is soaked in the aqueous solution for a period of time to increase crispness of the fresh produce, to kill bacteria on the fresh, produce and to cause the fresh produce to resist recontamination or cross-contamination from bacteria.

### CROSS-REFERENCE TO RELATED APPLICATION

The present invention claims priority to U.S. Provisional Patent Application Ser. No. 61/483,315 entitled COMPOSITION AND METHOD FOR TREATING FRESH PRODUCE and filed on May 6, 2011, which is incorporated in its entirety by this reference.

### BACKGROUND OF THE INVENTION

1. Field of the Invention

The present invention relates generally to chemical solutions for the treatment of fresh produce and more specifically to a chemical composition for treating fresh produce that extends the shelf life of fresh produce and decreases the amount of bacteria present on fresh produce using a chemical solution that is safe for consumption.

2. State of the Art

While businesses spend millions of dollars to ensure the delivery of safe, fresh produce. E. Coli, Salmonella, Listeria and other microbial pathogens in fresh food products have made the headlines of national news. In recent years the recall of spinach, cilantro and other fresh produce has heightened the awareness of the consumers to food safety. The general population has become more interested and more educated on the issue of food safety and the health benefits of fresh servings of fruits and vegetables. In addition, for retailers, the appearance of fresh produce is the difference between profit and loss. Fresh produce chat does not remain clean, fresh and appealing to the consumer mast, be discarded. As such, each year businesses lose millions of dollars because fruits and vegetables lose their crispness and freshness before they are purchased and become unsellable.

In recent times, organically grown foods have become more popular. In addition, produces that are certified as “organic” can be sold, at a premium, price. Foods that are produced using methods that do not involve modern synthetic: inputs such as pesticides and chemical fertilizers, do not contain genetically modified organisms, and are not processed using irradiation, industrial solvents, or chemical food additives. In order to be certified organic, only certain approved, substances can be used in the growing, harvesting and processing of food products and certain methods must be followed.

For decades, producers and retailers of fresh fruit and vegetables have sought to develop procedures for extending the shelf life of perishable goods. This has of tern involved the use of chemical compositions to treat the outer surfaces of such fresh produce in order to reduce spoilage due to microbiological and pathogen infiltration. On such method that has been employed for decades is to disinfect fresh produce by washing the produce in chlorinated water. Chlorination has been found to inactivate or destroy pathogenic bacteria, fungi, viruses, cysts and other microorganisms that can be introduced to fresh produce during propagation, harvesting, handling and marketing display. Most commonly, chlorinated water has been used for the cooling water in postharvest treatments as well as in rehydration at storage facilities.

Because it was previously believed that chlorination was safe, it was commonly the practice to utilize high chlorine concentrations. More recently, however, it has been discovered that the chlorination process commonly used on fresh produce can incompletely oxidize organic matter and thus produce undesirable byproducts. For example, use of chlorine to treat fresh produce can produce chloroform, a known carcinogen at high doses. Moreover, at high pH, chlorine reacts with organic nitrogen-based materials to produce mildly toxic chloramines. Moreover, chlorination kills bacteria by contact and once the produce has been treated, the bacterial killing effects of chlorination are no longer present. As such, if bacteria are reintroduced to the produce during transport or handling, the previous chlorination process will not detour or affect new bacterial growth.

Once fresh produce is received from a supplier by a retail store, the produce is removed from crates, inspected for freshness and washed. When produce is harvested, it may have a water content of ninety to ninety-six percent depending on the particular type of produce. Once harvested, the produce will begin to dehydrate and continue to do so until it is rehydrated, typically at the retail store level. Most commonly, the produce is removed from, crates and placed in large sinks filled with cool water for a period of time to allow the produce to absorb the water and restore crispness to the produce. In such, rehydration procedures, as more produce is added to the cool water bath, bacterial cross-contamination occurs between individual produce units and the bacterial concentration in the water rises with each successive unit of produce added to the water. In many cases, there is little if any cleaning of the sink or changing of water during any particular shift when produce is being soaked for rehydration. As such, it is sometimes the case that the processing at stores introduces more bacteria to the produce than is present after harvesting.

After the produce has been rehydrated, it is then placed in elongated refrigerated units that allow easy open access by consumers while providing some degree of refrigeration in order to extend the shelf life of the goods. In addition, water spraying units have been installed in many such refrigeration units to minimize dehydration of the produce as it sits on the shelf. In reality, however, such water spraying units nave little effect on the rate of dehydration of the produce.

Even with such in-store measures, because of the usually short shelf life of fresh produce, significant potential revenue is lost for goods that must be discarded once the goods begin to snow signs of deterioration and become no longer sellable. In addition, harmful concentrations of bacteria can be present, on the produce and there are no means for reducing cross-contamination at the store level.

Thus, there is a need in the art to provide a composition and solution for washing ad rehydrating fresh produce that not only extends the shelf life of the produce by enhancing crispness, but that cleans and has disinfecting properties to kill bacteria on fresh, produce and that continues to have a bacteria killing effect after use to prevent future contamination of the fresh produce that may occur from cross-contamination or introduction of bacteria during further handling of the fresh produce. In addition, there is a need in the art to provide a composition and solution for rehydrating, cleaning and extending the shelf life of fresh produce that uses organically acceptable substances in order to maintain organic certification of the fresh produce and that does not noticeably change the flavor of the fresh produce.

### SUMMARY OF THE INVENTION

Accordingly, a method for cleaning and increasing crispness of fresh produce includes providing a chemical composition in a dry form comprising sodium chloride, citric acid, ascorbic acid and D-alpha-tocopheryl acetate. The chemical composition is added to water to form an aqueous solution. Fresh produce is soaked in the aqueous solution for a period of time to increase crispness of the fresh produce, to kill bacteria on the fresh produce and to cause the fresh produce to resist cross-contamination and recontamination with bacteria.

According to the present invention, the chemical composition can be provided in a powder or granular form to be dissolved in water.

In one embodiment, the chemical composition is comprised of sodium chloride having a percentage by weight of about 48% to 72%, citric acid having a percentage by weight of about 29% to 45%, ascorbic acid having a percentage by weight of about 2.4% to 3.6% and D-alpha-tocopheryl acetate having a percentage by weight of about 0.008% to 0.012%.

In another embodiment, the chemical composition is comprised of sodium chloride having a percentage by weight of about 54% to 66%, citric acid having a percentage by weight of about 33% to 41%, ascorbic acid having a percentage by weight of about 2.7% to 3.3% and D-alpha-tocopheryl acetate having a percentage by weight of about 0.008% to 0.011%.

In yet another embodiment, the chemical composition is comprised of sodium chloride having a percentage by weight of about 57% to 63%, citric acid having a percentage by weight of about 34% to 40%, ascorbic acid having a percentage by weight of about 2.85% to 3.15% and D-alpha-tocopheryl acetate having a percentage by weight of about 0.0095% to 0.0105%.

In still another embodiment, the chemical composition is comprised of sodium chloride having a percentage by weight of about 60%, citric acid, having a percentage by weight, of about. 37%, ascorbic acid having a percentage by weight of about 3% and D-alpha-tocopheryl acetate having a percentage by weight of about 0.01%,

To treat fresh produce using the chemical composition of the present invention, an aqueous solution is formed by mixing the chemical composition with water. In order to form the solution, approximately 8 ounces of the chemical composition in dry form is added to approximately 24 gallons of water and mixed until dissolved.

It is desirable to form a 5% to 7% aqueous solution of the chemical composition.

In one embodiment, the water is warm water having a temperature of approximately 92 to 97 degrees Fahrenheit prior to soaking the fresh produce. Thus, the fresh produce is soaked in the aqueous solution at the elevated temperature.

Depending on the type of fresh produce, the fresh produce is soaked in the solution for between approximately 20 seconds and 15 minutes.

In the case of romaine lettuce, red leaf lettuce, green leaf lettuce, spinach, kale, Swiss chard, mustard greens collard greens, green onions, celery, baby bib lettuce, escarole, endive and other leafy greens, as well as cut carrots, soaking times range from approximately 5 minutes to 10 minutes.

In the case of iceberg lettuce, shredded iceberg lettuce, cilantro, parsley, cut cucumbers and bell peppers, soaking times range from approximately 1 minute to 2 minutes.

Berries are soaked for approximately 20 seconds and still obtain the benefits of the solution of the present invention.

Once the fresh produce has been treated in a bath of the aqueous solution of the present invention, the fresh produce is removed from the aqueous solution and cooled by such methods as dunking or rinsing in cool water (approximately 40 to 50 degrees Fahrenheit) or by placing in a refrigerated cooler that may be at a temperature of approximately 35 to 45 degrees Fahrenheit). Rapid cooling of the fresh produce after treatment causes the pores in the fresh, produce to close and seal in absorbed aqueous solution and increases the crispness of the treated fresh produce.

After each batch of produce is treated, which may include several units of produce (e.g., multiple heads of lettuce at once), the previously used aqueous solution can be reused for successive soakings or treatments of additional batches of fresh produce. This is possible because of the bacteria eliminating or killing properties of the aqueous solution of the present invention as well as the capability of the aqueous solution to penetrate the fresh produce during treatment and reduce if not virtually eliminate cross-contamination between successive batches.

These and other advantages and features will become apparent from the following detailed description of the various embodiments of the invention and associated drawing figures.

### BRIEF DESCRIPTION OF THE DRAWINGS

FIG. 1 is a graph illustrating a first set of test results using a composition and method of treating fresh produce according to the principles of the present invention.

FIG. 2 is a graph illustrating a second set of test results using a composition and method of treating fresh produce according to the principles of the present invention.

FIG. 3 is a graph illustrating a third set of test results using a composition and. method of treating fresh produce according to the principles of the present invention.

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons.

The present invention pertains to compositions, solutions and methods of using such compositions and. solutions to extend the shelf life and reduce bacteria content on fresh, that is, uncooked, fruits and vegetables (referred to herein as “fresh produce”). A water soluble composition is mixed with water before application to rehydrate fresh produce, extend the shelf life of fresh produce, decrease bacteria on fresh produce and provide a residual bacteria reducing affect after treatment to prevent recontamination or cross-contamination. The composition enhances the texture, appearance and crispness of the fresh produce while eliminating nearly all of the bacteria present on the fresh produce. A method of treating fresh produce with, the composition according to the present invention uses a combination of substances in powder form that are dissolved in water and applied to the fresh produce by soaking the fresh produce in the solution.

Application of the composition and solution of the present invention according to the present invention inhibits wilting of leafy fresh produce, such as lettuce, cilantro and. spinach, for an extended, period of time while also killing bacteria that has contaminated the fresh produce, whether during harvesting or preparation for display by a retail store. The exact length of the period, of enhanced, shelf life depends upon the initial fresh produce quality, the species and the variety of the fresh produce, the growing and storage conditions and the harvesting and handling techniques used to bring the fresh produce to market. The period of preservation can also be extended by adding refrigeration to the method after-treatment. The compositions and solutions, and method of using the compositions and solutions offer the advantage in that the fresh produce can be displayed in normal ambient conditions in a retail store. The method, does not require that the fresh produce be stored under vacuum or inert atmosphere. In addition, the use of the compositions and solutions of the present invention does not require the use of preservatives such as sulfites. In addition, even after the fresh produce has been displayed for a period of time, the fresh produce can be removed from the shelves and. retreated with the composition and solution of the present invention as set forth herein in order to rehydrate the produce to return the produce to a fresher state.

The composition for cleaning the fresh produce, significantly reducing bacteria content on the fresh produce and extending the shelf life of fresh produce includes a combination of sodium, chloride, anhydrous citric acid, ascorbic acid and D-alpha-tocopheryl acetate (Vitamin E). The composition may be provided in powder or granular form so as to be mixed with water to form, a solution. The solution can then be applied according to the methods of the present invention to treat fresh produce.

In one particular combination of ingredients, the composition includes approximately 60% by weight sodium chloride, approximately 37% by weight of citric acid, approximately 3% by weight of ascorbic acid and 0.01% by weight of vitamin E. The individual quantities of the individual ingredients may vary by approximately 20% and still be capable of producing some, if not all, of the desired affects accomplished by the present invention. The specifically enumerated amounts, however, are balanced to limit any palatable detection of the composition on treated fresh produce while enhancing the rehydration and disinfecting properties of the composition of the present invention. For example, increasing the amount of sodium chloride could increase the crispness of the fresh produce, but could result in the detection of salt in the flavor of the produce and a lowering of the disinfecting properties of the solution.

Citric acid is recognized as safe by all major national and international food regulatory agencies and is approved by the U.S. Food and Drug Administration for use in food. In the present invention, the citric acid has been found to exhibit antioxidant and preservative affects when applied to fresh produce and thus helps to extend the shelf life of the fresh produce and prevent bacteria growth. Moreover, the citric acid has been found to stabilize the color in the resulting solution and maintain a neutral taste in the flavor of the solution so that the solution does not impart a taste to the treated fresh produce.

The ascorbic acid (vitamin C) targets enzymes in the food that continue to metabolize after harvest. The enzyme phenolase, for example, goes to work as soon as an apple or potato is cut and causes the exposed surface to brown. Citric acid inhibits phenolase by lowering the pH so that the enzyme fails to react with the surface of the produce. In addition, most microorganisms grow best in a neutral pH environment of around 7. Such microorganisms also cannot grow in an acidic environment. Adding ascorbic acid increases the acidity of the environment to limit bacterial and fungal growth. Ascorbic acid is a sugar acid provided for its antioxidant properties and because it is water-soluble. The ascorbic acid may also be in the form of one of its sodium, potassium or calcium salts. Also, the fat-soluble esters of ascorbic acid with, long-chain fatty acids (ascorbyl palmitate or ascorbyl stearate) can be used.

Vitamin E is the generic term for tocopherols and tocotrienols. Vitamin E is a family of α-, β-, γ-, and δ- (respectively: alpha, beta, gamma, and delta) tocopherols and corresponding four tocotrienols. The vitamin E in the composition of the present invention acts as a fat-soluble antioxidant that stops the production of reactive oxygen species formed when fat undergoes oxidation and prevents oils from going rancid and other damage to the food due to exposure to oxygen. The vitamin E blocks the formation of free radicals in the food fats by stabilizing their molecular structure.

The composition of the present invention comprises sodium chloride, citric acid, ascorbic acid and vitamin E. The composition in a dry granular form further comprises sodium chloride in a percentage by weight of about 48% to 72%, citric acid in a percentage by weight of about 29% to 45%, ascorbic acid a percentage by weight of about 2.4% to 3.6% and vitamin E in a percentage by weight of about 0.008% to 0.012%. In a particular embodiment, the composition comprises sodium chloride in a percentage by weight of about 54% to 66%, citric acid in a percentage by weight of about 33% to 41%, ascorbic acid a percentage by weight of about 2.7% to 3.3% and vitamin S in a percentage by weight of about. 0.008% to 0.011%, In yet another embodiment, the composition comprises sodium chloride in a percentage by weight of about 57% to 63%, citric acid, in a percentage by weight of about 34% to 40%, ascorbic acid a percentage by weight of about 2.85% to 3.15% and vitamin E in a percentage by weight of about 0.0095% to 0.0105%.

It should be noted that the specifically recited compounds include related salts thereof where applicable, and the recitation of such compounds in the claims is intended to encompass such salts.

A method of treating fresh produce according to the principles of the present invention includes the steps of providing a composition of sodium chloride, citric acid, ascorbic acid and vitamin E in powder or granular form, dissolving the composition in water to form an aqueous solution and soaking fresh produce in the aqueous solution for a period of time. The ratio of water to the composition is approximately 24 gallons water to 8 ounces of the dry composition so that an approximately 5% solution is formed.

The method of treating fresh produce further involves the steps of preparing the fresh produce by, for example when treating leafy greens such as lettuce, spinach, cilantro or parsley, includes removing poor quality leaves and trimming of the butt ends. It is desirable to trim, as little as possible from the fresh produce to maximize the quantity of produce that can. be used. A sink or other water receptacle is filled with warm water having a temperature of approximately 92 to 97 degrees Fahrenheit. Use of warm water to increase hydration of fresh produce is counter-intuitive as it is generally known that use of warm water on fresh produce, especially leafy green produce, may cause the produce to wilt. Thus, it is most common in the industry to use cool water in order to increase crispness. In order to allow the compounds in the solution of the present invention to penetrate the leaves of the produce, use of warm water causes pores in the surface of the leaves to open, and allow absorption of the solution into the produce. Use of cool water would cause the pores in the leaves to close and prevent absorption of the solution.

The dry composition of ingredients is added to the warm water in an amount of approximately 8 ounces per 24 gallons of water or approximately one ounce per three gallons of water to form an aqueous solution. The fresh produce to be treated is placed in the aqueous solution (conditioning water) and allowed to soak for five to ten minutes. This causes any dirt on the surface of the fresh, produce to loosen and become dispersed in the aqueous solution. Interesting, no scrubbing or other physical contact is required to remove soil contaminants from the fresh produce. Different times may be appropriate for certain vegetables or types of vegetables. Table I provides a list of recommended soaking times for various fresh vegetables.

TABLE I

| VEGETABLES | DWELL TIMES | VEGETABLES | DWELL TIMES |
|---|---|---|---|
| ROMAINE | 5-10 Min. | ICEBERG LETTUCE | 1-2 Min. |
| RED LEAF | 5-10 Min. | SHREDDED ICEBERG | 1-2 Min. |
| GREEN LEAF | 5-10 Min. | CILANTRO | 1-2 Min. |
| SPINACH | 5-10 Min. | PARSLEY | 1-2 Min. |
| KALE | 5-10 Min. | CUT CUCUMBERS | 1-2 Min. |
| SWISS CHARD | 5-10 Min. | CUT BELL PEPPERS | 1-2 Min. |
| MUSTARD GREENS | 5-10 Min. | CUT TOMATOES | 1-2 Min. |
| COLLARD GREENS | 5-10 Min. | RADISHES | 1-2 Min. |
| GREEN ONIONS | 5-10 Min. | SPRING SALAD MIX | 1-2 Min. |
| CELERY | 5-10 Min. | GRAPES | 15 Min. |
| BABY BIB | 5-10 Min. | BERRIES | 20 Sec. |
| LETTUCE | | | |
| ESCAROLE | 5-10 Min. | CUT CARROTS | 5-10 Min. |
| ENDIVE | 5-10 Min. | | |

once absorbed will use the added water content to increase and extend crispness of the fresh produce after cooling. As will be explained in more detail, the aqueous solution can be reused for multiple batches due to its bacteria killing effect.

Once treated, the fresh, produce will be virtually bacteria free on its outer surface that has been treated, and will become bacteria resistant to help prevent cross-contamination. Unlike prior art methods of eliminating bacteria, such as use of chlorinated water, use of the composition of the present invention as described herein has a residual bacteria killing or resistant effect. Treatment of fresh produce with chlorinated water will kill bacteria that are contacted by the chlorinated water. Once the produce is removed from the chlorinated, water, however, recontamination can occur, either by cross-contamination or improper handling. Fresh produce treated as set forth herein, however, will continue to resist bacteria growth, even after the fresh produce is removed from the aqueous solution. This helps to prevent cross-contamination and can limit the reintroduction of bacteria after treatment due to improper handling. In addition, the fresh produce will be resistant to spore and mold growth. Finally, the fresh produce will retain crispness for an extended period of time on store shelves, as compared to untreated fresh produce. These effects in combination significantly extend the shelf life of the product once treated by increasing the water content of the fresh, produce and eliminating bacteria and spores that could infiltrate the produce if allowed to grow causing the fresh produce to begin the decay process prematurely.

Thus, the present, invention provides a chemical mixture and resulting solution that increases the stability and shelf life of fresh produce. The present invention provides a chemical solution that counteracts the decay, increases water content to enhance crispness and prevents recontamination after treatment. This is achieved with a chemical solution that is comprised of ingredients that are approved by the Food and Drug Administration as being safe for human consumption and that allows the fresh produce to maintain any “Organic” certification.

These test results were compared to other tests performed for a composition containing sodium chloride, citric acid, ascorbic acid, sodium acid pyrophosphate (SAPP) and vitamin E. The composition in a dry granular form included sodium chloride in a percentage by weight of about 57%, citric acid in a percentage by weight of about 34%, ascorbic acid in a percentage by weight of about 3%, SAPP in a percentage by weight of about 6% and vitamin E in a percentage by weight of about 0.00066%. The aerobic plate count testing indicated a one log reduction in bacterial load was achieved when rinsing fresh produce in an aqueous solution containing the aforementioned five ingredients. This equates to a 90% reduction in bacterial count. While this solution did exhibit some promising results, there were several drawbacks that needed to be addressed and were solved by the composition of the present invention. First, while SAPP is approved for consumption by the FDA, this approval is for use in baked goods. Because organic certification has strict guidelines for fresh produce, it was desirable to eliminate SAPP from the composition. In order to be successful, however, any new formulation needed to be as at least as effective in bacteria removal. In addition, after an aqueous solution of the SAPP containing formula is made, it begins to turn yellow and will eventually turn brown. In order to make such, a product, sellable in liquid firm, it needs to remain clear for an extended period of time since consumers are not willing to coat fresh produce in a brown liquid.

By removing the SAPP from the composition and readjusting the remaining ingredients, significant and unexpected results were achieved. Since SAPP is a known food additive, generally known to maintain color in foods and to improve water holding capacity, it was extremely surprising to discover that removal of the SAPP resulted in a product that remained clear without yellowing or browning for an extended period, of time when formed, into an aqueous solution. More surprising, however, was the antibacterial effect that removal of SAPP from the composition had.

In order to verify the effectiveness of the chemical solution of the present invention, various tests were conducted. These tests were conducted to determine the effectiveness of the product to reduce bacteria on various fresh produce.

In one test, green leaf lettuce was subjected to

a wash process using the chemical solution of the present invention. In one set of tests, a 5% solution was employed with another set. of tests conducted using a 7% solution. The green leaf lettuce was inoculated with salmonella (ATCC #14028), Escherichia Coli (ATCC #25922), and Listeria Monocytogenes (ATCC #19115) and soaked for 10 minutes at 96.8° F. in a 5% chemical solution or a 7% chemical solution. The goal was to see which treatment provided the best log reduction in bacteria content and to verify that the composition formula was at least as effective as the combination of ingredients containing SAPP, The test was administered at the Analytical Laboratories facility in Boise, Idaho. Based on the log values recovered for Salmonella and Escherichia Coli, there was not a significant difference between the 5% chemical solution wash process and the 7% chemical solution wash process. For Listeria Monocytogenes, however, the 5% chemical solution wash process actually had a higher log reduction of 4.20 than the 7% chemical wash, process of 2.55.

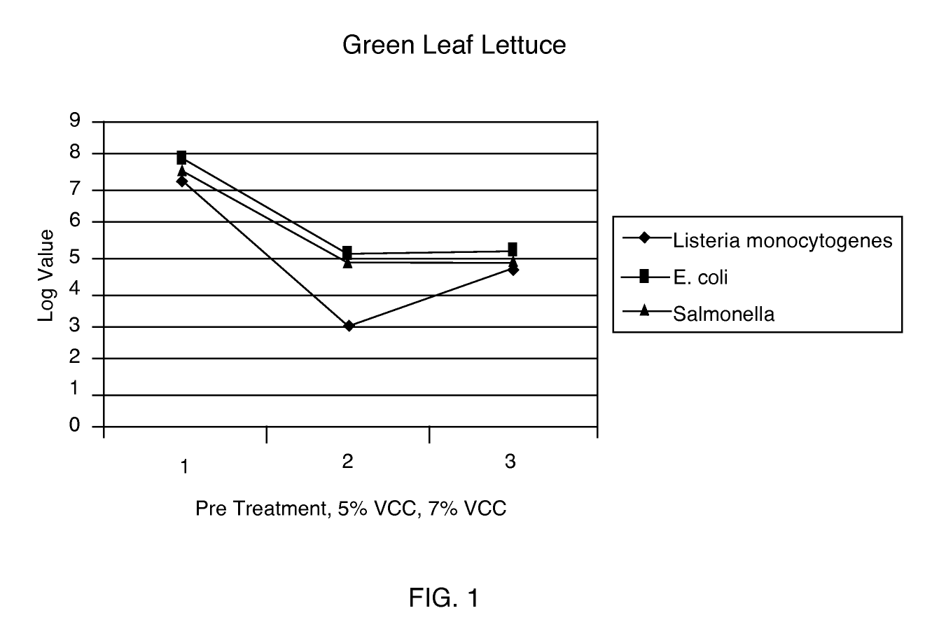

The individual treatment sample recovery counts (colony forming units per gram, CFU/g) and corresponding log values for Salmonella were as follows, as illustrated in graphical form in FIG. 1:

### Treatment Raw Count Log Value

Control 30,100,000 CFU/g 7.48

5% aqueous solution 75,000 CFU/g 4.87

7% aqueous solution 64,000 CFU/g 4.81

The individual treatment sample recovery counts (colony forming units per gram, CFU/g) and corresponding Log values for Escherichia Coli are as follows, as illustrated in graphical form in FIG. 1:

### Treatment Raw Count Log Value

Control 76,000,000 CFU/g 7.88

5% aqueous solution 114,000 CFU/g 5.06

7% aqueous solution 137,000 CFU/g 5.14

The individual treatment sample recovery counts (colony forming units per gram, CFU/g) and corresponding Log values for Listeria Monocytogenes are as follows, as illustrated in graphical form in FIG. 1:

### Treatment Raw Count Log Value

Control 15,700,000 CFU/g 7.20

5% aqueous solution 1,000 CFU/g 3.00

7% aqueous solution 45,000 CFU/g 4.65

Another set of tests were conducted to determine

the effectiveness of the composition of the present invention using a 5% solution wash process when used, on grapes. The Grapes were inoculated with Salmonella (ATCC #14028), Escherichia Coli (ATCC #25922), and Listeria Monocytogenes (ATCC #19115) and soaked for 10 minutes at 96.8° F. in a 5% aqueous solution. The goal was to see if the process was effective at removing bacteria from grapes.

Based on the log values recovered for Salmonella, Escherichia Coli, and Listeria Monocytogenes the 5% aqueous solution wash process was effective at reducing the bacterial load, by 2.35 to 3.71 logs, depending on the bacteria. The recovered counts and corresponding log values are listed, as well as a corresponding graph depicting the log reduction of the treatment process per bacterium.

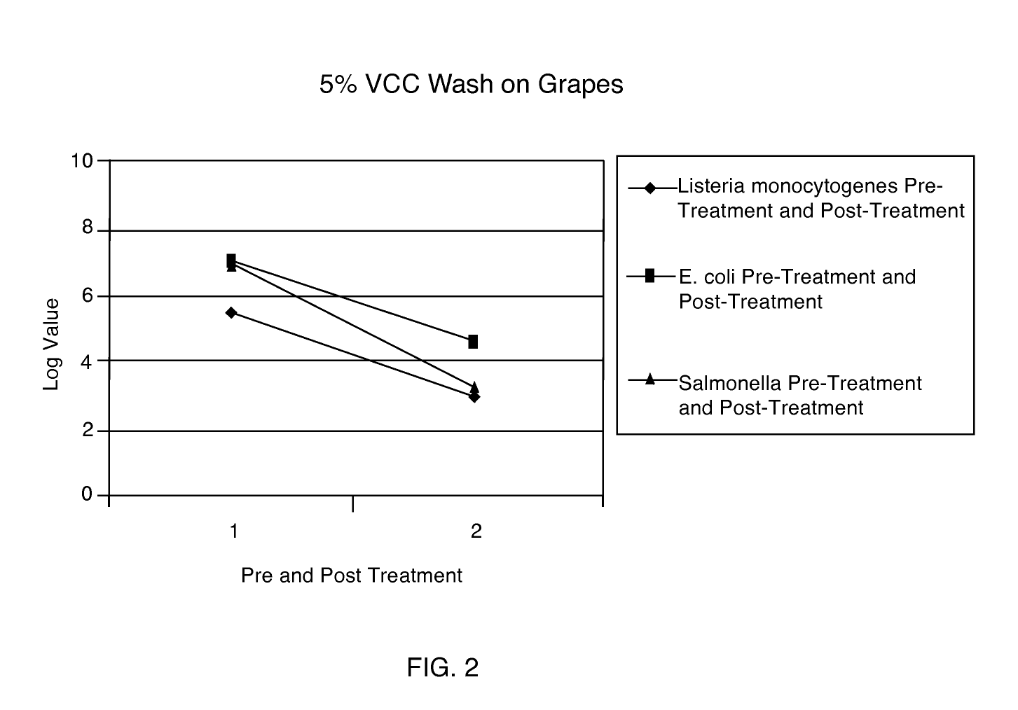

The individual treatment sample recovery counts (colony forming units per gram, CFU/g) and corresponding log values for Escherichia Coli are as follows, as illustrated in graphical form in FIG. 2:

### Treatment Raw Count Log Value

Control 10,100,000 CFU/g 7.00

5% aqueous solution 45,000 CFU/g 4.65

The individual treatment sample recovery counts (colony forming units per gram, CFU/g) and corresponding hog values for Salmonella are as follows, as illustrated in graphical form in FIG. 2:

### Treatment Raw Count Log Value

Control 10,300,000 CFU/g 7.01

5% aqueous solution 2,000 CFU/g 3.3

The individual treatment sample recovery counts (colony forming units per gram, CFU/g) and corresponding hog values for Listeria Monocytogenes are as follows, as illustrated in graphical form in FIG. 2:

### Treatment Raw Count Log Value

Control 300,000 CFU/g 5.48

5% aqueous solution <1,000 CFU/g <3

The intent of the third analysis performed was to determine the effectiveness of the 5% aqueous solution wash process of the present invention at inhibiting a possible cross-contamination of bacteria. Red leaf lettuce was inoculated with Salmonella (ATCC #14028), Escherichia Coli (ATCC #25922), and Listeria Monocytogenes (ATCC #19115) and soaked for 10 minutes at 96.8° F. in a 5% aqueous solution with an un-inoculated piece of green leaf lettuce. The goal was to see if the wash process was effective at removing bacteria from the red leaf lettuce and not transferring the known bacteria to the green leaf lettuce.

Based on the log values recovered for Salmonella, Escherichia Coli, and Listeria Monocytogenes the 5% aqueous solution wash process was effective at reducing the bacterial load on the red leaf lettuce and appeared to not cross-contaminate the green leaf lettuce whatsoever. This is evident in the consistent reduction of bacterial growth seen for both the red leaf lettuce and green leaf lettuce. The recovered counts and corresponding log values are listed, as well as a corresponding graph depicting the log reduction of the treatment process per bacterium.

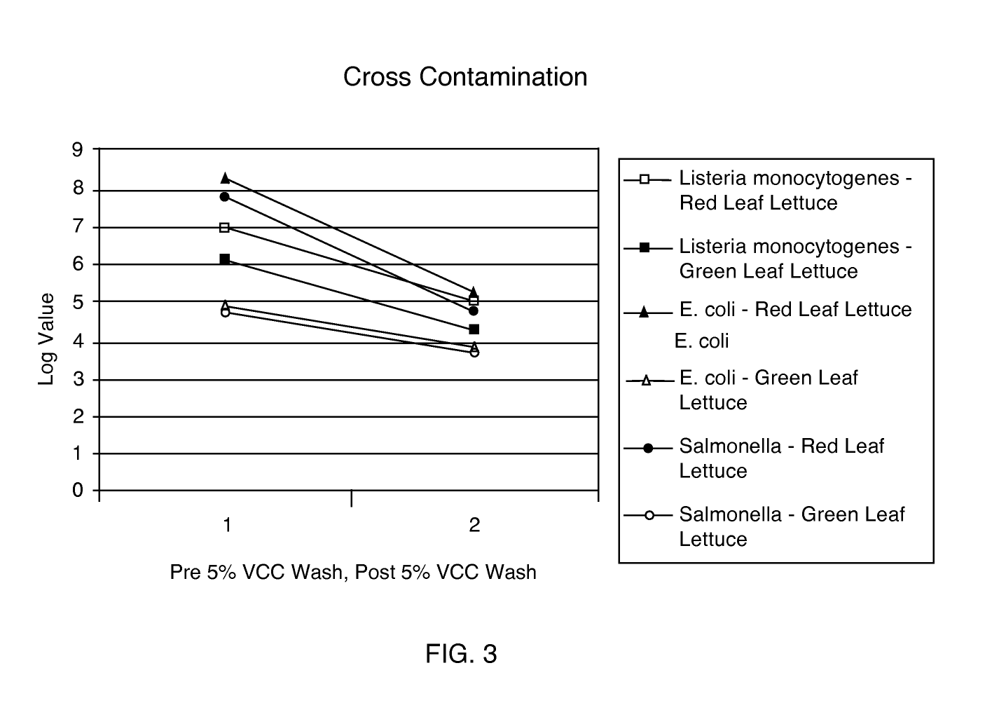

The individual treatment sample recovery counts (colony forming units per gram, CFU/g) and corresponding log values for Escherichia Coli are as follows, as illustrated in graphical form in FIG. 3:

### Treatment—Red Leaf Lettuce Raw Count Log Value

Control 188,000,000 CFU/g 8.27

5% aqueous solution 174,000 CFU/g 5.24

### Treatment—Green Leaf Lettuce

Control 80,000 CFU/g 4.9

5% aqueous solution 6,000 CFU/g 3.78

The individual treatment sample recovery counts (colony forming units per gram, CFU/g) and corresponding Log-values for Salmonella are as follows, as illustrated in graphical form in FIG. 3:

### Treatment—Red Leaf Lettuce Raw Count Log Value

Control 58,000,000 CFU/g 7.76

5% aqueous solution 58,000 CFU/g 4.76

### Treatment—Green Leaf Lettuce

Control 48,800 CFU/g 4.67

5% aqueous solution 4,000 CFU/g 3.60

The individual treatment sample recovery counts (colony forming units per gram, CFU/g) and corresponding Log values for Listeria Monocytogenes are as follows, as illustrated in graphical form in FIG. 3:

### Treatment—Red Leaf Lettuce Raw Count Log Value

Control 7,900,000 CFU/g 6.90

5% aqueous solution 115,000 CFU/g 5.06

### Treatment—Green Leaf Lettuce

Control 1,310,000 CFU/g 6.12

5% aqueous solution 18,000 CFU/g 4.26

The foregoing test results demonstrate that not only is the non SAPP formula effective, it is 100 to 1000 times more effective at reducing bacteria on fresh produce, from a 1 log reduction in the SAPP containing formula to a 3 to 4 log reduction in the non-SAPP formula. Moreover, the non-SAPP formula has shown the ability to increase the shelf life of the produce by up to 40% over the SAPP containing formula. This is particularly surprising since SAPP is known to cause water retention in foods and have a preservative effect that prevents discoloration. Thus, for produce that typically has a shelf life of a couple of days, use of the SAPP containing formula would extend the shelf life to about one week with the non-SAPP formula extending the shelf life another two to 3 days beyond that. In addition, bacterial cross-contamination was shown to be virtually eliminated. No other chemical composition is known that does not alter the flavor of the food, is safe for human consumption and approved by the Food and Drug Administration, does not affect the organic certification of the produce, significantly increases the water content and shelf life of fresh produce and continues to have antibacterial affects to prevent cross-contamination and resist reintroduction of bacteria. Indeed, use of the chemical composition of the present invention will save grocers millions of dollars by extending the shelf life and thus the salability of fresh produce that would otherwise become unsellable and will significantly limit bacterial food contamination that would otherwise make consumers sick and subject grocers and suppliers of fresh produce to significant liability. It is important to note that once treated produce is displayed for a period of time and the produce begins to wilt due to dehydration, so long as the produce has not begun to display signs of decay, the produce can be retreated with the aqueous solution of the present invention to rehydrate the produce to further extend the shelf life.

It would be apparent to those skilled in the art that some other ingredients may be added to the composition of the present invention, including equivalent compounds and substances without departing from the spirit and scope of the present invention. Thus, while there nave been described various embodiments of the present, invention, those skilled in the art will recognize that other and further changes and modifications may be made thereto without department from the spirit of the invention, and it is intended to claim all such changes and modifications that fall within the true scope of the invention. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods of use and compositions of the present invention are described herein, any methods or substances similar or equivalent to those described herein may be used in the practice or testing of the present invention. All references cited herein are incorporated by reference in their entirety and for all purposes. In addition, while the foregoing advantages of the present invention are manifested in the illustrated embodiments of the invention, a variety of changes can be made to the composition of the invention to achieve those advantages including combinations of ingredients of the various embodiments. Hence, reference herein to specific details of the compositions and function of the present invention is by way of example only and not by way of limitation.

What is claimed is:

1. A method for cleaning and increasing crispness of fresh produce, comprising:
providing a chemical composition in a dry form comprising:
sodium chloride;
citric acid;
ascorbic acid; and
D-alpha-tocopheryl acetate;
adding the chemical composition to water to form an aqueous solution; and
soaking fresh produce in the aqueous solution for a period of time to increase crispness of the fresh produce, to kill bacteria on the fresh produce and to cause the fresh produce to resist cross-contamination and recontamination with bacteria.

2. The method of claim 1, further comprising providing the chemical composition in powder or granular form,

3. The method of claim 1, further comprising providing the chemical composition with sodium chloride in a percentage by weight of about 48% to 72%, citric acid in a percentage by weight of about 29% to 45%, ascorbic acid a percentage by weight. of about 2.4% to 3.6% and D-alpha-tocopheryl acetate in a percentage by weight of about 0.008% to 0.012%.

4. The method of claim 1, further comprising providing the chemical composition with sodium chloride in a percentage by weight of about 54% to 66%, citric acid in a percentage by weight of about 33% to 41%, ascorbic acid a percentage by weight of about 2.7% to 3.3% and D-alpha-tocopheryl acetate in a percentage by weight of about 0.008% to 0.011%.

5. The method of claim 1, further comprising providing the chemical composition with sodium chloride in a percentage by weight of about 57% to 63%, citric acid in a percentage by weight of about 34% to 40%, ascorbic acid a percentage by weight of about 2.85% to 3.15% and D-alpha-tocopheryl acetate in a percentage by weight of about 0.0095% to 0.0105%.

6. The method of claim 1, further comprising providing the chemical composition with approximately 60% by weight of the sodium chloride, approximately 37% by weight of the citric acid, approximately 3% by weight of the ascorbic acid and 0.01% by weight of the D-alpha-tocopheryl acetate.

7. The method of claim 1, further comprising providing the aqueous solution with a ratio of water to the chemical composition of approximately 24 gallons of water to 8 ounces of the chemical composition.

8. The method of claim 1, further comprising forming an approximately 5% aqueous solution from the water and chemical composition.

9. The method of claim 1, further comprising providing the water with a temperature of approximately 92 to 97 degrees Fahrenheit prior to soaking the fresh produce and soaking the fresh produce in the aqueous solution at the temperature.

10. The method of claim 1, further comprising soaking the fresh produce for between approximately 20 seconds and 15 minutes.

11. The method of claim 10, further comprising soaking at least one of romaine lettuce, red leaf lettuce, green leaf lettuce, spinach, kale, Swiss chard, mustard greens collard greens, green, onions, celery, baby bib lettuce, escarole, endive and carrots for approximately 5 to 10 minutes.

12. The method of claim 10, further comprising soaking at least one of iceberg lettuce, shredded, iceberg lettuce, cilantro, parsley, cucumbers and bell peppers for approximately 1 to 2 minutes.

13. The method of claim 10, further comprising soaking berries for approximately 20 seconds.

14. The method of claim 1, further comprising removing the fresh produce from the aqueous solution and cooling the fresh produce to cause pores in the fresh produce to close and seal in absorbed aqueous solution and to increase crispness of the fresh produce.

15. The method of claim 14, further comprising reusing the aqueous solution for successive soaking of additional batches of fresh produce.

16. A chemical composition for cleaning and increasing crispness of fresh produce, comprising:
sodium chloride;
citric acid;
ascorbic acid; and
D-alpha-tocopheryl acetate.

17. The chemical composition of claim 16, wherein said sodium chloride, citric acid, ascorbic acid and D-alpha-tocopheryl acetate are in a powder or granular form.

18. The chemical composition of claim 16, wherein said sodium chloride has a percentage by weight of about 48% to 72%, said citric acid has a percentage by weight of about 29% to 45%, said, ascorbic acid has a percentage by weight of about 2.4% to 3.6% and said D-alpha-tocopheryl acetate has a percentage by weight of about 0.008% to 0.012%.

19. The chemical composition of claim 16, wherein said sodium chloride has a percentage by weight of about 54% to 66%, said citric acid has a percentage by weight of about 33% to 41%, said ascorbic acid has a percentage by weight of about 2.7% to 3.3% and said D-alpha-tocopheryl acetate has a percentage by weight of about 0.008% to 0.011%.

20. The chemical composition of claim 1, wherein said sodium chloride has a percentage by weight of about 57% to 63%, said citric acid has a percentage by weight of about 34% to 40%, said ascorbic acid has a percentage by weight of about 2.85% to 3.15% and said D-alpha-tocopheryl acetate has a percentage by weight of about 0.0095% to 0.0105%.

21. The chemical composition of claim 16, wherein said sodium chloride has a percentage by weight of about 60%, said citric acid has a percentage by weight of about 37%, said ascorbic acid has a percentage by weight of about 3% and said D-alpha-tocopheryl acetate has a percentage by weight of about 0.01%.

22. The chemical composition of claim 16, further comprising water to form an aqueous solution,

23. The chemical composition of claim 22, wherein said aqueous solution is an approximately 5% solution.

24. The chemical composition of claim 22, wherein said water has a temperature of approximately 92 to 97 degrees Fahrenheit.

25. The chemical composition of claim 24, wherein said aqueous solution is reusable for a plurality of batches of fresh produce and prevents cross-contamination between each of said plurality of batches.
